(19) United States
(12) Patent Application Publication
(10) Pub. No.: US 2006/0112009 A1
(43) Pub. Date: May 25, 2006

(54) Deferred compensation method

(75) Inventors: Richard D. Ehrhart, Charlotte, NC (US); Michael Edward McGarry, Charlotte, NC (US)

Correspondence Address: KENNEDY COVINGTON LOBDELL & HICKMAN, LLP, 214 N. TRYON STREET, HEARST TOWER, 47TH FLOOR, CHARLOTTE, NC, 28202, US

(73) Assignee: Optcapital, LLC, Charlotte, NC (US)

(21) Appl. No.: 11/286,673

(22) Filed: Nov. 23, 2005

Related U.S. Application Data
(60) Provisional application No. 60/630,648, filed on Nov. 24, 2004.

(51) Int. Cl. G06Q 40/00

(52) U.S. Cl. 705/40

(57) ABSTRACT

A method of deferring compensation. One or more initial payment dates over a period of time are selected on which a portion of compensation is to be paid. At least twelve months prior to each initial payment date, the initial payment date is rescheduled to a subsequent payment date at least five years later. Method may be repeated over a plurality of years. Bucket accounting procedures may be used in determining valuation of the deferred compensation benefit associated with each payment date. By giving required notice, deferred compensation recipients may prevent automatic rescheduling of payment dates and thereby receive deferred compensation on such payment dates.

### CROSS-REFERENCE TO RELATED APPLICATIONS

This application claims priority under 35 U.S.C. § 119 of U.S. Provisional Application Ser. No. 60/630,648 filed on Nov. 24, 2004, the disclosure of which is incorporated herein by reference.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

1. Technical Field

The present invention relates to the field of compensation and more particularly to a method of providing nonqualified deferred compensation to employees or other service providers.

2. Background Information

Deferred compensation is compensation payable to a service provider (such as an employee or independent contractor) that is paid more than a brief time after the taxable year of the service provider in which the services that earned the compensation were rendered and that is includable in the federal gross income of the service provider in the taxable year in which it is actually received. Employers or other entities desiring to pay deferred compensation typically establish and adopt a deferred compensation plan (hereinafter, a “Plan”) setting forth the rights and responsibilities of plan participants. Participants in deferred compensation plans typically execute written agreements with the employer or plan sponsor. Thus, deferred compensation plans are implemented by executing legally binding agreements defining the obligations of the parties involved.

For convenience, the terms “participant,” “employee,” “recipient,” or “service provider” are used herein to refer to persons entitled to receive deferred compensation.

Two primary categories of deferred compensation are “qualified” deferred compensation (hereinafter “QDC”) and “nonqualified” deferred compensation (hereinafter “NQDC”). A QDC plan is a deferred compensation plan that satisfies the requirements set forth in Section 401(a) of the Internal Revenue Code (hereinafter, the “IRS Code”). QDC plans are usually established and maintained by an employer primarily to provide for the payment of benefits to employees over a period of years, usually for life, after retirement.

Because QDC plans satisfy the strict requirements set forth in Section 401(a), QDC plans are eligible to receive very favorable tax treatment. Employer contributions to QDC plans constitute a business deduction in determining the employer's taxable income. Employer contributions are not regarded as employee earnings and are, therefore, not taxable to the employee. The earnings of QDC are not subject to current income tax. A 401(k) Plan is one common type of QDC plan.

Maintaining compliance with section 401(a), however, can be a complex endeavor. Section 401(a) contains specific rules regarding, for example, minimum plan coverage, minimum plan participation, nondiscrimination among employees, eligibility and vesting. Generally, these requirements are designed to prevent QDC plans from discriminating in favor of highly-compensated employees. Additionally, the amount of deferred compensation that can be awarded as QDC is limited. As a result, QDC is inadequate as a tax-deferred compensation tool for many executives and other highly-paid service providers.

A NQDC plan does not meet the requirements set forth in Section 401(a). Despite the fact that NQDC plans do not receive all of the favorable tax treatment that QDC plans receive, there are advantages to NQDC plans that result primarily from the fact that NQDC plans are not subject to the same restrictions as QDC plans. For example, there is no limit to the amount of deferred compensation that can be paid to an employee or service provider in NQDC. Moreover, an employer can pick and choose which employees are to be covered by a NQDC plan. Participation in a NQDC plan can be made voluntary or mandatory. NQDC may be in lieu of current compensation or supplemental to other compensation. NQDC thus represents a significant way in which many employers attract, retain and compensate senior executives and other key personnel.

Subject to Section 409A, which is discussed below, an employer has wide latitude in designing its NQDC plans. Calculation of the NQDC benefit can be based on a “defined credit” or “defined benefit” formula. A defined benefit plan is one in which the benefit payable to the NQDC recipient is known in advance. For example, pension plans providing that upon retirement an employee will receive a predetermined amount of money every month are examples of defined benefit plans.

A defined credit plan, on the other hand, defines the benefit payable to the recipient either in terms of what is credited to the plan and left to grow (or decline) until payment or by reference to property such as securities whose value will fluctuate between the issuance of the deferred compensation and the payment thereof. Defined credit valuation can be based on almost anything, including a stock price and dividends, mutual fund price and dividends, an index or a stated rate of growth.

Several types of known NQDC plans include: voluntary deferral plans, defined benefit supplemental retirement plans, defined contribution supplemental retirement plans and change in control benefit plans.

In a voluntary deferral plan, participants may elect to forgo all or a portion of their salary or bonuses and receive in lieu thereof a credit to the NQDC plan equal to the forgone salary or bonus. The credits are increased or decreased according to the valuation formula stated in the plan document. A participant's benefit equals the participant's plan account.

In a defined benefit supplemental retirement plan, an employer promises to pay a defined benefit (which is often expressed as a percentage of the employee's salary) commencing at a specific time in the future (such as retirement). Typically, the benefit is reduced by benefits payable under the employer's qualified defined benefit pension plan and social security. The benefit is typically defined as a term certain annuity, a life annuity or a joint and survivor life annuity.

In a defined contribution supplemental retirement plan, an employer promises to pay a benefit based on a defined credit account. Typically, the credits are calculated based on a formula that takes into account contributions made under the employer's qualified defined contribution pension plan.

A significant characteristic of NQDC is that care must be exercised to ensure that the deferred compensation to be received by a service provider in the future is not includable in the service provider's gross income for federal tax purposes until such actual receipt of the deferred compensation in the future. Indeed, it would be a significant disadvantage for most service providers to incur federal income tax liability on compensation that will not be received until some later point in time, which may be years away.

In order to avoid federal income tax on deferred compensation until actual receipt thereof by the recipient, a NQDC plan must avoid the application of both the constructive receipt doctrine, which is set forth in IRS Code Section 451, and the economic benefit doctrine, which is set forth in IRS Code Section 83. Application of either these doctrines can cause NQDC to be taxable before the participant actually receives such deferred compensation. In addition, a NQDC plan must also comply with Section 409A, which is discussed below.

If the deferred compensation is payable in the form of property, it is subject to IRS Code Section 83 and will be taxable to the employee at the earlier of when the property is “transferable” by the employee or is not subject to a “substantial risk of forfeiture.” Section 83 is not applicable to the unfunded promise to pay cash or property, because the term “property,” as defined in the regulations under IRS Code Section 83, does not include money or an unfunded and unsecured promise to pay money or property in the future. A “substantial risk of forfeiture” exists if “such person's rights to full enjoyment of the property are conditioned upon the future performance of substantial services by any individual.”

The concept of constructive receipt can be summarized in the following way: income although not actually reduced to a taxpayer's possession is constructively received by him in the taxable year during which it is credited to his account, set apart for him, or otherwise made available so that he may draw upon it at any time, or so that he could have drawn upon it during the taxable year if notice of intention to withdraw had been given. However, income is not constructively received if the taxpayer's control of its receipt is subject to substantial limitations or restrictions. A common substantial limitation is the passage of time.

The economic benefit doctrine can be characterized as follows: a person is deemed to have realized income if an amount is set aside for that person in such a manner as to ensure that the person will eventually enjoy such money or property. An example of an arrangement held to fall within the economic benefit doctrine is an arrangement in which an employer places money in a trust for an employee outside the reach of the employer's creditors (even in bankruptcy), and directs the trustee to distribute the money to the employee upon completion of a specified time period. If the amount set aside for than individual is subject to a substantial risk of forfeiture, however, then the economic benefit doctrine will not apply.

To avoid application of the constructive receipt and economic benefit doctrines, and thereby achieve deferral of taxation on deferred compensation until actual receipt by the service provider, it is common to structure NQDC plans to consist solely of an employer's or other entity's unfunded and unsecured promise to pay the employee or other service provider a specified benefit at termination of employment or at a specified future date. This creates a substantial limitation or restriction upon a recipient's ability to receive the NQDC because plan participants must wait until a future date in order to receive the benefit and because plan participants thus have no interest in any asset of the employer or plan sponsor and thereby become general, unsecured creditors of the employer with respect to their NQDC benefits. Thus, participants in known NQDC plans bear the risk of the employer's or plan sponsor's financial stability and continued existence. If the employer or other obligator of a NQDC plan becomes insolvent or files for bankruptcy protection before the service provider's receipt of the NQDC benefit, the deferred compensation benefits may very well end up going to the employer's creditors and not being paid to the service provider. This is a significant risk for the service provider, who has already provided the services for which the deferred compensation was earned.

As a logical extension of avoiding the application of the constructive receipt doctrine, and thereby achieving deferral of taxation on deferred compensation until actual receipt by the service provider, it is known to preclude participants from exercising control over the timing of benefit payments. Generally, benefits are paid at termination of employment either in a lump sum or in installments over a fixed number of years. This, along with the participant's status as a general unsecured creditor, subjects the benefit to a substantial risk of forfeiture. If the participant elects a lump sum, taxes on a career's worth of saving are due in one day, drastically diminishing the asset. Conversely, if an installment payout is chosen, the participant effectively makes an unsecured long-term loan to the employer without any power or right to accelerate payment for any reason. Concerns about the truly unsecured nature of an installment payout cause many participants, even employees of strong, healthy companies, to opt for the lump sum payout.

In an attempt to address the significant deficiencies associated with known NQDC plans, employers and plan sponsors have sought ways to provide plan participants with some control over their NQDC benefits. It is now common for participants to exercise some control over the NQDC by having the ability to select the underlying investments that serve as “yardsticks” for determining the growth or decline—i.e., the valuation—of NQDC benefits. For example, a NQDC plan may provide that the amount of deferred compensation awarded will appreciate or depreciate during the period between its award and payment of the benefit by the same amount that a widely recognized financial index, such as the S&P 500, rises or falls during the same period, or by the amount that a particular stock or mutual fund price rises or falls during the same period.

Notwithstanding that employers or plan sponsors cannot fund known NQDC plans in a way so as to put such funding out of reach of the employer's or sponsor's creditors in the event of the employer's insolvency, many employers and plan sponsors do informally fund their NQDC obligations. Typically, such informal funding consists simply of the employer setting aside, or earmarking, assets for the purpose of providing a source of payment of benefits or a source of reimbursement of benefits the employer pays. The employer must take care to ensure the absence of facts and circumstances that could give rise to a claim by participant of a property right in such assets.

If the employer chooses to informally fund a plan, the employer has many choices in how it informally funds NQDC benefits. Formulation of a funding strategy generally involves many considerations. A primary consideration is the funding objectives and prioritization of such objectives. For example, the primary objective may be to provide a source of payment of NQDC benefits, and to ensure that the value of the funding assets very closely approximates the value of the NQDC liabilities (i.e., a “tight hedge”). Or, the objective may be to fund only the after-tax cost of the benefit. The income tax cost of investments is always a consideration, and the choice of tax-favored investments, such as corporate-owned life insurance (“COLI”) or index mutual funds, sometimes requires a tradeoff with the tight hedge objective.

Another consideration is whether to set aside the assets irrevocably in a trust, or to simply hold them as part of the employer's general assets. The employer can establish a grantor, or “rabbi trust” to which it makes contributions for investment, accumulation and to provide a source of payment of NQDC benefits. The rabbi trust can be irrevocable and its assets made to be outside the reach of employer creditors except in the case of employer insolvency. In the event of employer insolvency, the trust's assets must become available to the employer's creditors.

On Oct. 22, 2004, The American Jobs Creation Act of 2004 was signed into law and added Section 409A to the IRS Code. Section 409A adds a layer of requirements to the federal income tax rules governing nonqualified deferred compensation. If an employee is owed NQDC that fails to satisfy Section 409A, the employee is subject not only to back taxes with interest, but a 20% penalty calculated on the sum of the NQDC plus interest. Moreover, the employer is required to withhold the tax. It is important to keep in mind that a failure can arise from either a failure of the Plan's provisions to comply, or a failure of the actual operation of the Plan to comply.

Among other things, Section 409A established four new sets of constructive receipt rules. These rules are in addition to all of the rules existing before enactment of Section 409A. As a result, all such existing rules concerning constructive receipt, economic benefit and assignment of income continue to apply. To achieve tax deferral, the compensation must not only satisfy such existing rules, but the new 409A rules as well.

First, with respect to initial elections, amounts deferred at the participant's election can avoid adverse tax consequences only if the election to defer is made before the beginning of the calendar year in which services are performed. There are two exceptions to this initial election rule. A participant may make an election to defer compensation during the calendar year in which the participant first becomes eligible to participate, provided the election is made during the first thirty days of eligibility. Also, a participant can make a deferral election with respect to “performance-based” compensation up to six months before the end of the 12-month performance measurement period.

Second, under Section 409A, the initial deferral election must specify the time or times for payment of benefits that are being deferred. The amounts deferred can avoid adverse tax consequences only if the Plan provides that benefit payments (distributions) may not be made any earlier than the occurrence of one of six specified events: participant's separation from service; participant's disability; participant's death; a change in control of the employer or Plan sponsor; participant's unforeseeable financial emergency; and a time or times specified at the time of the initial deferral election. Notwithstanding the language of Section 409A, the IRS has adopted the position that amounts deferred can avoid adverse tax consequences only if the Plan provides that payments may be made only upon the occurrence of one of these events. The IRS has also adopted the position that Section 409A applies not only to deferrals under an account balance plan, but to compensatory options issued at a discount as well (although fair market value options and fair market value appreciation rights granted on an employer's common stock are exempt from Section 409A).

Third, amounts deferred can avoid adverse tax consequences only if the Plan does not permit the acceleration of the time or schedule of any payment under the Plan. Thus, traditional “hair cut” rules under which participants had the right to withdraw their benefits at any time subject to a substantial penalty or “haircut” are now prohibited.

Fourth, amounts deferred can avoid adverse tax consequences if the Plan permits a subsequent election to postpone a payment or change the form of payment only under the following conditions. Any such subsequent election may not take effect until at least twelve months after the election is made. If the election relates to a distribution to be made on separation from service, a specified time or a change in control, then the payment with respect to the election must be postponed by at least five years. If the election relates to a payment to be made at a specified time, then it must be made at least twelve months before the date the payment would have otherwise been made.

As is evident from the above discussion, there are significant restrictions placed upon participants in traditional NQDC plans, especially in light of the recently-enacted Section 409A. Because traditional NQDC plans consist merely of an employer's unfunded, unsecured promise to pay a specified amount of cash or provide a specific value of property at termination of employment or at a specified time in the future, plan participants bear the risk of the employer's or plan sponsor's future insolvency. Moreover, participants must often make an election before the calendar year in which the corresponding services are performed and such election must specify the time or times for payment of benefits that are being deferred. Any change in such initial election must be made at least twelve months in advance and any change in distribution schedule must further defer such payments for at least five additional years. Moreover, because the previously-common practice of permitting early distribution as long as a participant is willing to absorb the associated “hair cut” is no longer permissible, participants electing to defer portions of their income face very serious long term credit risks and payment inflexibility.

Clearly, what is needed in the art is a new method of providing deferred compensation that complies with the recently enacted Section 409A, but also minimizes the risk that an employer or plan sponsor insolvency will cause the beneficiaries of such deferred compensation to lose such benefits. Ideally, such new method of providing deferred compensation would allow plan participants to exercise control not only of the underlying financial investments that determine the plan benefit, but also of the timing of NQDC benefit payments without penalty.

### SUMMARY OF THE INVENTION

The present invention overcomes the disadvantages associated with known methods of providing deferred compensation by providing a new method of nonqualified deferred compensation in which one or more initial payment dates are selected to occur over a predetermined period of time and amounts of deferred compensation to be paid on each initial payment date are determined. Then, prior to each initial payment date, the initial payment date is rescheduled to a subsequent payment date in the future.

Prior to the rescheduling of each initial payment date, a service provider may cancel the rescheduling of such initial payment date. In such event, on such initial payment date the service provider receives that portion of the deferred compensation associated with such initial payment date.

By advantageously selecting the number of initial payment dates and the amount of time during which such payment dates occur, a service provider is able to achieve an opportunity to receive a relatively uniform cash flow during the deferral compensation payment period while at the same time minimizing the credit risk associated with being an unsecured creditor by minimizing the duration of deferred compensation benefits. In a preferred embodiment of the present invention, twenty initial payment dates are selected to occur over a five-year period.

Each subsequent payment date may be five years or more after each such initial payment date and each initial payment date may be rescheduled at least twelve months prior to each initial payment date. The first initial payment date is at least twelve months after the selection of the initial payment dates.

The portion of compensation payable on each initial payment date may be determined by crediting a predetermined amount of the compensation earned by a service provider to each initial payment date as such compensation is earned by the service provider.

A computer may be used to credit a predetermined amount of compensation earned by the service provider to each initial payment date as such compensation is earned by the service provider and to automatically reschedule each initial payment date to a subsequent payment date.

The method of the present invention may be performed by a party other than the service provider and the employer (or other party compensating the service provider). The method may be repeated over a number of years in which a service provider is eligible to receive deferred compensation.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### BRIEF DESCRIPTION OF THE DRAWINGS

For a more complete understanding of this invention reference should now be had to the preferred embodiments illustrated in greater detail in the accompanying drawings and described below. In the drawings:

FIG. 1 illustrates a prior art NQDC relationship;

FIG. 2 illustrates timing restrictions present in prior art NQDC;

FIG. 3 illustrates a NQDC method according to a preferred embodiment of the present invention; and

FIGS. 4-9 illustrate examples of preferred embodiments of the present invention.

### DESCRIPTION OF PREFERRED EMBODIMENTS

The present invention will now be described fully hereinafter with reference to the accompanying drawings, in which preferred embodiments of the invention are shown. This invention may, however, be embodied in many different forms and should not be construed as limited to the preferred embodiments set forth herein. Rather, these preferred embodiments are provided so that this disclosure will be thorough and complete, and will fully convey the scope of the invention to those skilled in the art. It will be understood that all alternatives, modifications, and equivalents are intended to be included within the spirit and scope of the invention as defined by the appended claims.

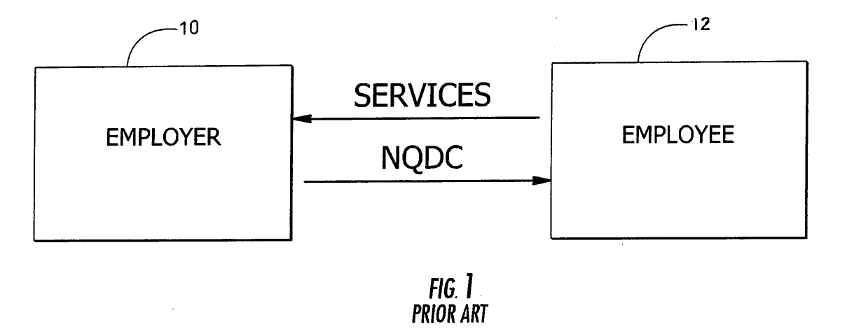

Turning initially to FIG. 1, there is illustrated a traditional prior art NQDC relationship. In this relationship, an employee 12 provides services to an employer 10. In exchange, the employer 10 provides NQDC to the employee. As discussed above, prior art NQDC consists merely of the employer's 10 unfunded, unsecured promise to pay the employee 12 a given amount of money or provide property at a subsequent time period.

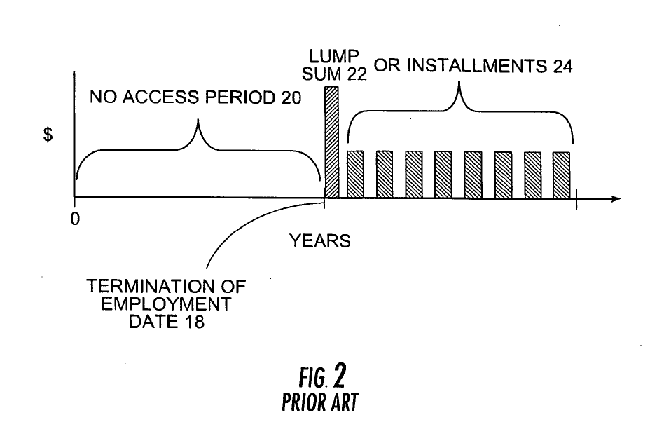

FIG. 2 illustrates the limitations on an employee's right to receive NQDC under prior art NQDC plans. For the purpose of illustration, FIG. 2 assumes that NQDC is awarded to an employee in year zero and that the employee becomes eligible to receive the NQDC benefits at the date of termination of employment 18. There is thus a no access period 20 during which the employee cannot receive benefits under the prior art NQDC plan. At the employment termination date 18, the employee 12 can receive either a lump sum payment 22, which will be taxable in the year of receipt, or begin receiving equal installments 24. In this example, the prior art NQDC plan provides for eight equal installments, each of which will be taxable to the employee 12 in the year of receipt.

Two significant limitations faced by participants in known NQDC plans are lack of liquidity and lack of any meaningful way to manage the credit risk associated with being a general unsecured creditor of an employer for a prolonged period of time.

Because Section 409A requires that deferred compensation payments be scheduled in advance and that any re-deferral payments be scheduled a minimum of five years after the originally scheduled payment dates, participants may well face a situation in which they undergo long periods in which no deferred compensation is payable followed by a very large amount of income that they must take in full (and pay the associated taxes) or re-defer for five years.

Moreover, because participants are general unsecured creditors of their employer or plan sponsor, participants face a credit risk associated with the financial condition of such employer or plan sponsor. The longer the average duration of the deferred compensation benefit, the greater the associated credit risk to the participant.

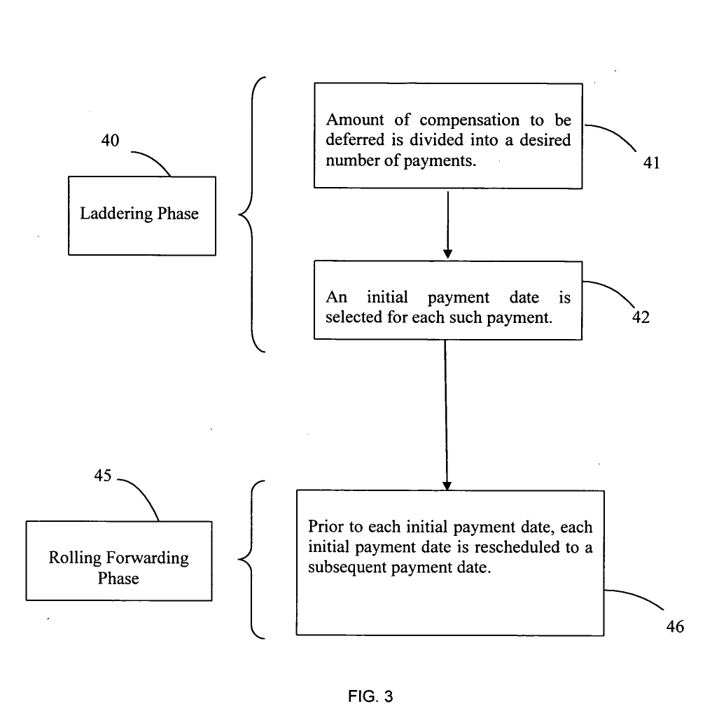

Advantageously, the present invention provides a deferred compensation method that minimizes the average duration of the deferred benefit and maximizes participant cash flow flexibility. As illustrated in FIG. 3, this method may be conceived of as involving two primary phases, which are referred to herein as “laddering” and “rolling forward.”

In the laddering phase 40, an amount of compensation to be deferred is divided into a desired number of initial payments 41 and a future payment date is selected for each such initial payment 42. While any number of initial payments may be selected, the actual number of initial payments used in the present invention often results from balancing a participant's 12 desire to obtain a future income stream with minimal time between payments so as to allow flexibility and the practical task of managing and accounting for a large number of such initial payments. Selecting a very small number of initial payments, i.e., one payment per year over a five year period for example, would be relatively easy to manage but would not provide a participant 12 with much liquidity potential because a participant would only have one opportunity per year to receive the deferred benefit. On the other hand, selecting a large number of initial payments, i.e., weekly payments over a five year period for example, would provide a participant 12 with much liquidity potential because a participant would have many opportunities per year to receive the deferred benefit, but doing so would be difficult to manage. Typically, the first initial payment is scheduled at least one year after the end of the year in the deferral election is made.

One particular way to ladder that may be advantageously used in the present invention is to divide compensation deferred in each year into twenty equal initial payments that are scheduled to be paid to the recipient 12 on a consecutively quarterly basis commencing in the first quarter of the year that is two years after the year in which the election to defer compensation is made. In this way, approximately five percent of the compensation deferred is available for payment to the service provider 12 in every calendar quarter during which such deferred compensation is payable.

Advantageously, the so-called “bucket” method of accounting may be employed to determine the valuation of the deferred compensation benefit that is credited to each initial payment date. In this method, a “bucket” of deferred compensation is notionally established for each of the selected initial payment dates. As an example, if twenty initial payment dates are selected over a five year period, then twenty such “buckets” are established. The buckets are then notionally “filled” with a service provider's deferred compensation benefit.

There are at least two ways to “fill” the buckets. In a preferred embodiment of the present invention, as compensation is deferred, the amount of such deferred compensation is divided by the number of buckets and the resulting quotient is credited to each bucket. Using this method, an approximately equal portion of all compensation deferred is credited to each of the buckets at the same time. As an example, if a service provider elects to defer $1000 of his monthly compensation and elects to receive such deferred compensation in twenty initial payments over a five year period, then each month at the time the service provider 12 would otherwise receive his or her monthly compensation $50 would be credited to each of the twenty buckets. As those in the art will appreciate, depending upon the number of buckets and the amount of compensation deferred, it may not be possible to divide the compensation equally among all of the buckets and so the amount of compensation credited to each bucket will be approximately equal, but may not be exactly equal.

Another way to “fill” the buckets is to fill each bucket sequentially. In this way, the total amount of compensation to be deferred during a deferral year is divided by the number of buckets to determine the amount of benefit representing a “full” bucket. Then, as compensation is deferred during the deferral year, all such compensation is credited to one particular bucket until that bucket is “full” and then this process continues sequentially until all buckets are filled.

Similarly, there are also various ways in which earnings (or losses) on the deferred compensation can be credited to each bucket. In one method, earnings (or losses) on the total amount of annual deferred compensation are credited approximately equally to each bucket. In another method, earnings (or losses) generated by each bucket are tracked and credited to each such bucket.

It should be noted that buckets are established only for use in association with a given deferral year. New buckets are established for use with compensation deferred in subsequent years. It is thus possible that buckets payable to a service provider in a given year may contain compensation that has been deferred from different years.

It is believed that use of the bucket method and accounting for earnings (or losses) on a bucket-by-bucket basis may be particularly advantageous because such methods result in a reliable audit trail of each dollar of compensation from deferral through payment. This may provide a defensible position to any assertion that plan operation results in an inadvertent—but prohibited—acceleration of benefits.

In the “rolling forward” phase 45, on a predetermined date prior to each initial payment date, each such initial payment date is rescheduled to a subsequent payment date 46. Advantageously, on the date that is at least one year prior to each initial payment date, each such initial payment date is rescheduled to a subsequent payment date that is five years after each such initial payment date. Also advantageously, a blanket authorization to automatically reschedule each initial payment date can be obtained from a participant 12 when the deferred compensation is elected and the initial payment dates are selected. In this way, such rescheduling of initial payment dates can occur automatically and without further action from the participant. Alternatively, participants could be required to periodically affirm their elections.

It should be noted that payment dates may be rolled forwarded more than one time. For example, an initial payment date may be rolled forward five years to a subsequent payment date, and then such subsequent payment date may itself be rolled forward five years, and so on.

Participants desiring to receive all or some of their deferred compensation must make such decision at least twelve months prior to receipt of such compensation or portion thereof. Thus, in order to receive such payments participants would merely cancel the automatic rescheduling of any scheduled initial payment dates on which they desire to receive compensation. As those in the art will appreciate, such decision to receive deferred compensation must be made at least twelve months prior to the initial payment date of any payment desired to be received and not rescheduled.

Scheduling initial payment dates on a quarterly or even monthly basis is advantageous because doing so provides participants greater flexibility of the timing and amount of deferred compensation payments. With respect to timing, because participants desiring to cancel the automatic rescheduling of scheduled initial payments must make such decision at least twelve months prior to the date on which such payment is scheduled to be received, if initial payments were scheduled only annually or semiannually then participants would have only one or two opportunities, respectively, to decide whether to receive any of the deferred compensation in the year following any particular year. If deferred payments are scheduled to be paid quarterly or even monthly, on the other hand, then participants will have four or twelve opportunities, respectively, to decide to take payments in the year following any particular year. With respect to amount flexibility, as the number of payments over which a particular benefit amount is spread increases, the amount of each payment decreases. If only one payment per year over a five year period is selected, then the only choice available to participants is to either accept a one-time payment of 20% of the deferred benefit of further defer such payment. Conversely, if twenty quarterly payments over a five-year period are selected, then each quarter participants will have the option of withdrawing (with the required notice) or further deferring 5% of the deferred benefit each quarter.

Participant flexibility can be further increased by scheduling compensation deferring in successive years to be paid on different dates than compensation deferred in earlier years.

In a preferred embodiment of the present invention, a participant is able to elect each year how much salary or bonus to defer and to minimize the average duration of the employer's benefit obligations. As used herein, “duration” refers to the length of time needed to receive fifty percent of a participant's deferred compensation benefit. By minimizing the duration, a participant can minimize credit exposure associated with employer insolvency and maximize liquidity, risk adjusted return on investment and flexibility.

Each year the participant makes a deferral election and specifies how much salary or bonus to defer during the next calendar year (hereinafter, the “Deferral Year”). Unless the participant elects otherwise, the benefit payments attributable to the deferrals will be paid during the second calendar year following the Deferral Year. The particular date that deferrals are paid (hereinafter, the “Deferral Date”) may be a particular anniversary of the date that such deferral was made or, advantageously, may be a date established in the Plan. For example, a Plan may provide for one quarterly payment of all deferred compensation payable in each quarter. The Plan may also provide that, unless the participant elects otherwise, prior to each scheduled initial payment date, the initial payment is automatically postponed by five years to a subsequent payment date.

A Deferred Compensation Plan that may be advantageously used in the present invention is provided as an Appendix, which is incorporated herein.

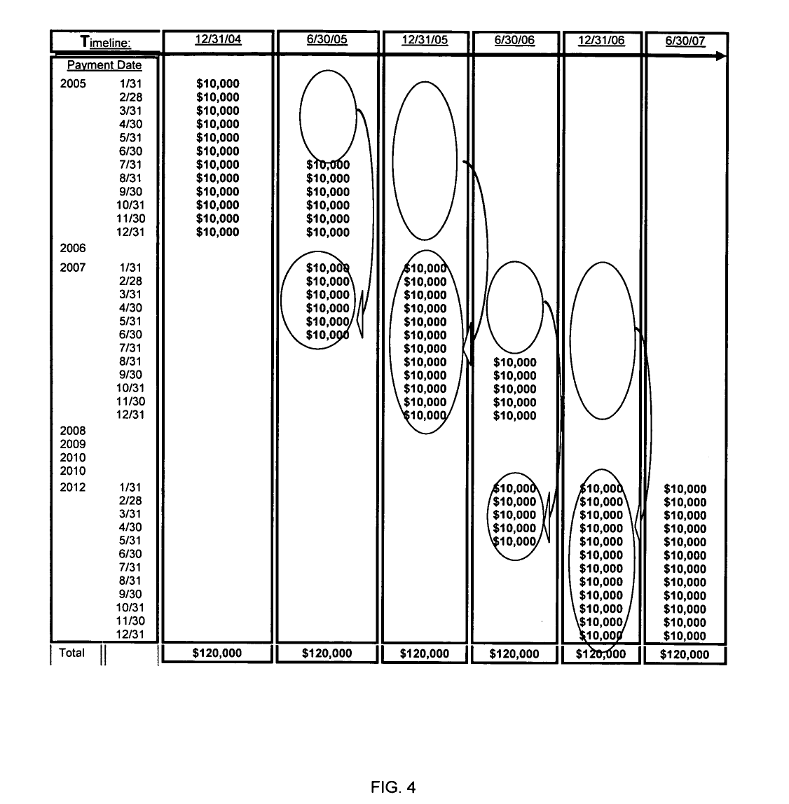

A preferred embodiment of the present invention is illustrated in FIG. 4, which illustrates a participant's decision in December 2004 (the “Election Year”) to defer $120,000 of salary payable in 2005 (the “Deferral Year”).

A participant may make such election by executing a deferral election document. A suitable deferral election document for use with the present invention would read as follows:
Under the [Company name] Deferred Compensation Plan, I hereby elect on Dec. 31, 2004 to defer $120,000 of my salary that would otherwise be paid to me during 2005. I understand that each Deferral will create a benefit that will be paid to me on the second (2^{nd}) anniversary of the Deferral Date (the “Payment Date”). I understand that with respect to each Payment Date there is a “Postponement Action Date.” The Postponement Action Date is the date 366 days prior to the Payment Date. On each Postponement Action Date, the Company is authorized and directed to postpone the related Payment Date by five years. Notwithstanding the foregoing, I understand that I (or my successor or assignee) may revoke this authorization with respect to any Payment Date provided I (or my successor or assignee) provide the Company with notice of such revocation before the related Postponement Action Date(s). I further understand that such notice shall be in such form as the Company shall reasonably require. I further understand that the term “Payment Date” refers to the date that a benefit is scheduled to be paid, whether such date is the date originally scheduled or a postponed date.

FIG. 4 shows, at 6-month intervals, the results of such 2004 Deferral Election. For the purposes of illustration, it is assumed that the deferrals do not grow or decline over time, although those in the art will recognize that such deferrals may grow or decline in value. As FIG. 4 illustrates, on Jan. 30, 2006 the benefit payable Jan. 31, 2007 would be rolled forward to Jan. 31, 2012. As each Postponement Action Date is reached without a revocation, the related Payment Date is postponed 5 years. By Dec. 30, 2006, all benefits have been postponed to 2012.

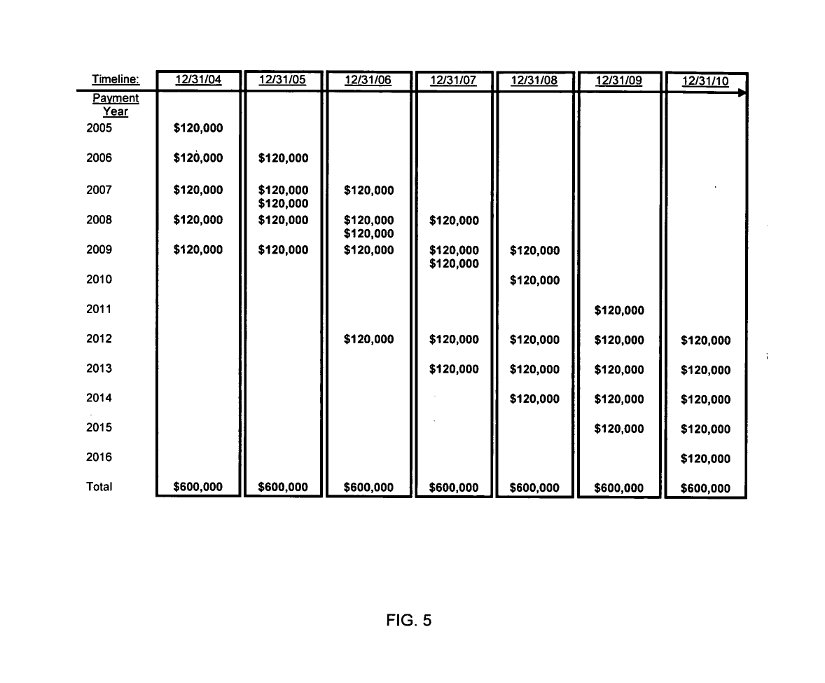

If in this example the participant elects to defer $120,000 of salary each year for 5 years, FIG. 5 illustrates the resulting future salary and benefits at the beginning of each year through 2011. For simplicity, only the Payment Date year, and not the month and day, are used in FIG. 5.

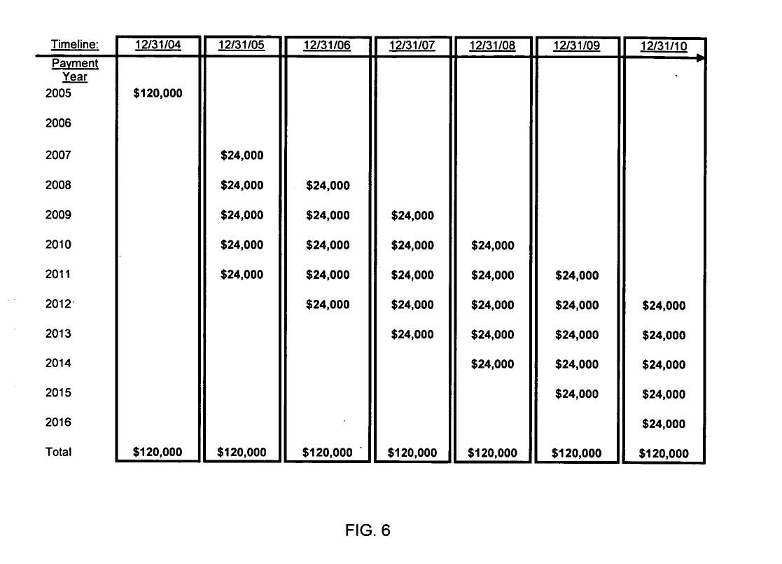

Another preferred embodiment of the present invention is illustrated in FIG. 6. In this embodiment, each deferral is subdivided into components and varying postponement periods are assigned to each such component. For example, it is likely that a participant would want to divide each deferral by 5 and assign Payment Date anniversaries of 2, 3, 4, 5 and 6 years to each component. FIG. 6 illustrates this situation. For simplicity, only the Payment Date year, and not the month and day, are used in FIG. 6.

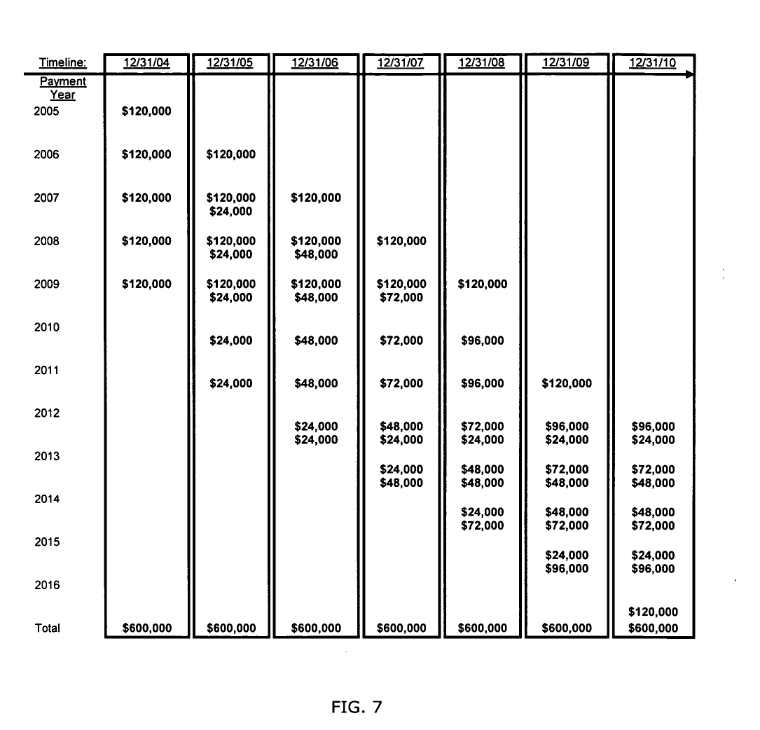

In another example, suppose a participant elects to defer $120,000 of salary each year for 5 years. FIG. 7 illustrates the participant's future salary and benefits at the beginning of each year through 2011. For simplicity, only the Payment Date year, and not the month and day, are used in FIG. 7.

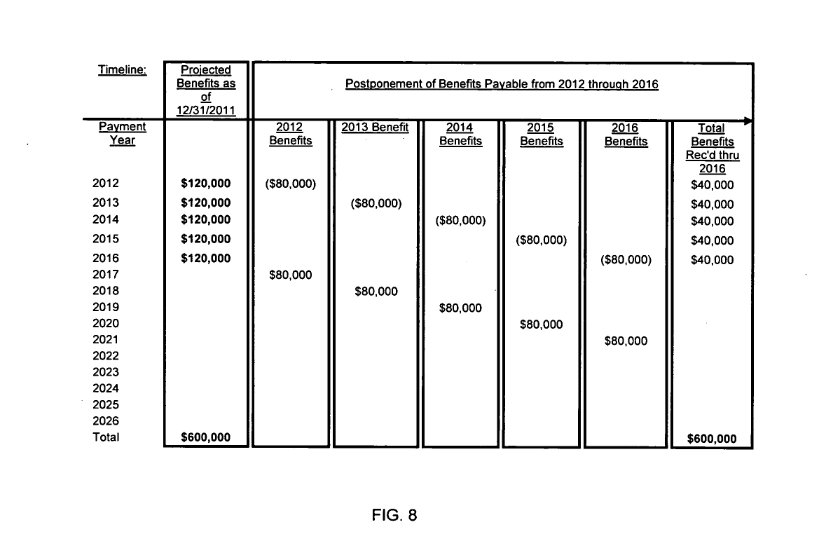

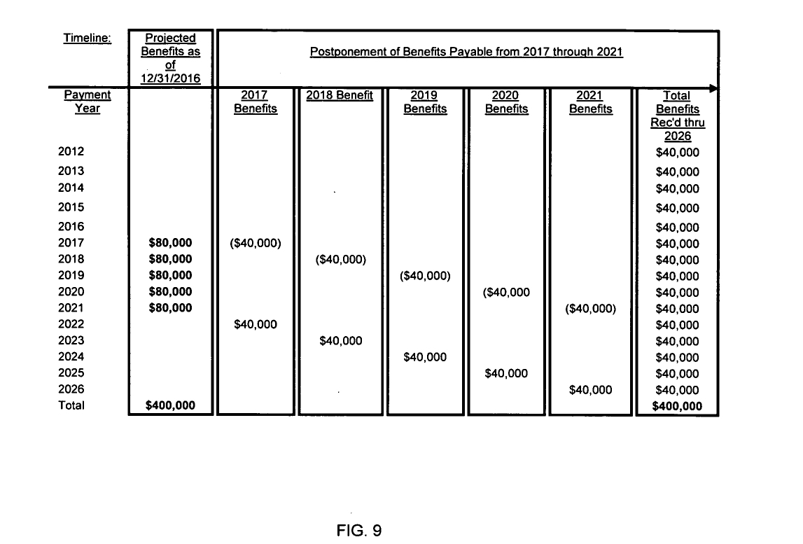

In addition to subdividing the initial deferral, the subdividing feature may be applied as well to Payment Dates after the initial deferral. For example, referring to FIGS. 8 and 9, if all Payment Dates are January 15, and if the participant retires as of Dec. 31, 2010. The present invention allows such participant to structure an installment payout that is longer than the 2012 through 2016 period. For example suppose the participant desires a 15-year payout beginning in 2012. Then, the subdivision and postponement features would again be applied.

There are various ways to subdivide and spread. For example, assuming that each Payment Date benefit is equal value, then each benefit may be multiplied by a fraction where the numerator is the number of years by which the payout is to be extended (10 in this case) and the denominator is the total number of years of the desired payout period (15 in this case). The product gives us the portion of the benefit to postpone.

Of course, each benefit is not equal. Benefits to be paid at a later date should be greater than those paid earlier. To create a more equal spreading, a different subdivision methodology could be used, such as a unit credit method. To apply unit credit, a certain amount of growth of the benefits over the initial period (5 years) could be assumed to calculate a future value at the end of the period, and then the present value of each year's benefit could be calculated to determine the relative contribution of each benefit to the future value. The resulting percentages could be used to subdivide and postpone.

While the preferred embodiments above are illustrated in the employer-employee context, it will be recognized by those skilled in the art that the present invention may also be advantageously utilized in other situations in which one party, such as a recipient of services, provides deferred compensation to a service provider, such as in the contractor-independent contractor situation.

Any type of defined contribution NQDC may be used with the present invention. Examples of such NQDC include 401K excess plans, voluntary deferral plans, supplemental retirement plans and the like. If options are used with the present invention, then those in the art will appreciate that instead of scheduling specific payment dates in the future, specific time periods are scheduled in the future during which the participant has the right to exercise such options. These specific exercise periods are then automatically rescheduled in accordance with the present invention. Those in the art will also appreciate that if options are desired for use, then an option arrangement is created in which the grant date spread, i.e., the difference between the value of the underlying security and the exercise or strike price, is equal to the amount of compensation desired to be deferred.

It should be recognized that because participants are sometimes allowed to select the investment vehicles in which deferred compensation is invested, or are allowed to change the investment index against which the value of deferred compensation will be adjusted, it is possible that the portion of deferred compensation corresponding to each scheduled payment date may not be equal. It thus may not be possible to arrange payment of the precise amount desired to be received by a participant. Thus, when a participant desired to receive a specific amount of deferred compensation in a particular future year, quarter or month, there may be different combinations of scheduled payments that could be exempted from automatic rescheduling that would provide such desired compensation amount to the recipient. In such cases, it would generally be most advantageous to exempt from rescheduling those payments that would come closest to providing the desired amount of money to the participant while allowing the most previously scheduled payments to be rescheduled.

Advantageously, using the method of the present invention participants do not have to make an irrevocable election of when deferred compensation will be paid in the future; each year participants can elect a particular amount of compensation to be deferred; participants can start and stop receipt of deferred compensation payments in the future; and participants can extend the length of time over which deferred compensation benefits can be payable. Significantly, this can be done before or after termination of employment or retirement. Those in the art will appreciate that known plans require participants to make an irrevocable payment election prior to the date of retirement. It should be noted that minimizing the time over which deferred compensation is payable is often desirable by participants because the longer such payments extended, the more risk of employer insolvency is assumed by the recipient.

The method of the present invention may be performed by an employee, an employer, a contractor hiring independent contractors, or by a third party administrator. Typically, when such services are provided by a third party administrator, the administrator receives compensation in exchange for such services.

It will be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A method of deferring a predetermined amount of compensation owed to a service provider comprising:
selecting one or more initial payment dates over a predetermined period of time on which at least a portion of such amount of compensation will be paid to the service provider;
determining the portion of the amount of compensation to be paid to the service provider on each of the initial payment dates; and
prior to each initial payment date, rescheduling payment of the portion of such amount of compensation that was scheduled to be paid to the service provider on such initial payment date to a subsequent payment date in the future.

2. A method of deferring a predetermined amount of compensation owed to a service provider as defined in claim 1 wherein each subsequent payment date is five years or more after each such initial payment date.

3. A method of deferring a predetermined amount of compensation owed to a service provider as defined in claim 1 wherein at least twelve months prior to each initial payment date each initial payment date is rescheduled to a subsequent payment date.

4. A method of deferring a predetermined amount of compensation owed to a service provider as defined in claim 1 wherein the portion of such amount of compensation to be paid on each initial payment date is determined by crediting a predetermined amount of compensation earned by the service provider to each initial payment date as such compensation is earned by the service provider.

5. A method of deferring a predetermined amount of compensation owed to a service provider as defined in claim 1 wherein at least twenty initial payment dates are selected.

6. A method of deferring a predetermined amount of compensation owed to a service provider as defined in claim 1 wherein sixty or more initial payment dates are selected.

7. A method of deferring a predetermined amount of compensation owed to a service provider as defined in claim 1 wherein the first initial payment date is at least twelve months after the selection of the initial payment dates.

8. A method of deferring a predetermined amount of compensation owed to a service provider as defined in claim 1 wherein the first initial payment occurs in the calendar year that is one year or more after the calendar year in which the initial payment dates are selected.

9. A method of deferring a predetermined amount of compensation owed to a service provider as defined in claim 1 wherein the portions of the amount of compensation to be paid on each of the initial payment dates are approximately equal.

10. A method of deferring a predetermined amount of compensation owed to a service provider as defined in claim 1 comprising the additional step of, prior to when each initial payment date is rescheduled, allowing the service provider to cancel the rescheduling of such initial payment date.

11. A method of deferring a predetermined amount of compensation owed to a service provider as defined in claim 10 comprising the additional step of paying to the service provider on each initial payment date for which the service provider cancelled rescheduling thereof that portion of such amount of compensation that was scheduled to be paid on such initial payment date.

12. A method of deferring a predetermined amount of compensation owed to a service provider as defined in claim 4 wherein a computer is used to credit the predetermined amount of compensation earned by the service provider to each initial payment date as such compensation is earned by the service provider and to automatically reschedule each initial payment date to a subsequent payment date.

13. A method of deferring a predetermined amount of compensation owed to a service provider as defined in claim 1 wherein each method step is repeated for each year of compensation in which a service provider defers at least a portion of compensation.

14. A method of deferring a predetermined amount of compensation owed to a service provider as defined in claim 1 comprising the additional steps of:
receiving a request from the service provider for payment of an amount of deferred compensation during the predetermined period of time;
selecting one or more initial payment dates or subsequent payment dates that would provide sufficient compensation to satisfy the service provider's request for payment if the compensation scheduled to be paid on such one or more initial payments dates or subsequent payment dates is paid and not rescheduled to a subsequent payment date; and
prior to when each of the one or more initial payment dates or subsequent payment dates selected is rescheduled, canceling the rescheduling of such one or more selected initial payment dates or subsequent payment dates.

15. A method of deferring a predetermined amount of compensation owed to a service provider comprising:
selecting twenty or more initial payment dates on which at least of portion of such amount of compensation will be paid to the service provider, the earliest of such initial payment dates to occur in the calendar quarter that is at least five calendar quarters after the calendar quarter in which such twenty initial payment dates are selected and the last such initial payment date to occur not more than five years after the earliest initial payment date;
determining the portion of the amount of compensation to be paid to the service provider on each of the initial payment dates by crediting a predetermined amount of compensation earned by the service provider to each initial payment date as such compensation is earned by the service provider; and
at least twelve months prior to each initial payment date, rescheduling each such initial payment date to a subsequent payment date that is at least five years after each such initial payment date.

16. A method of deferring a predetermined amount of compensation owed to a service provider as defined in claim 15 wherein the portions of the amount of compensation to be paid on each of the initial payment dates are approximately equal.

17. A method of deferring a predetermined amount of compensation owed to a service provider as defined in claim 15 comprising the additional step of, prior to when each initial payment date is rescheduled, allowing the service provider to cancel the rescheduling of such initial payment date.

18. A method of deferring a predetermined amount of compensation owed to a service provider as defined in claim 17 comprising the additional step of paying to the service provider on each initial payment date for which the service provider cancelled rescheduling thereof that portion of such amount of compensation that was scheduled to be paid on such initial payment date.

19. A method of deferring a predetermined amount of compensation owed to a service provider as defined in claim 15 wherein a computer is used to credit the predetermined amount of compensation earned by the service provider to each initial payment date as such compensation is earned by the service provider and to automatically reschedule each initial payment date to a subsequent payment date.

20. A method of deferring a predetermined amount of compensation owed to a service provider as defined in claim 15 wherein each method step is repeated for each year of compensation in which a service provider defers at least a portion of compensation.

21. A method of deferring a predetermined amount of compensation owed to a service provider as defined in claim 15 comprising the additional steps of:
receiving a request from the service provider for payment of an amount of deferred compensation during the predetermined period of time;
selecting one or more initial payment dates or subsequent payment dates that would provide sufficient compensation to satisfy the service provider's request for payment if the compensation scheduled to be paid on such one or more initial payments dates or subsequent payment dates is paid and not rescheduled to a subsequent payment date; and
prior to when each of the one or more initial payment dates or subsequent payment dates selected is rescheduled, canceling the rescheduling of such one or more selected initial payment dates or subsequent payment dates.

22. A method of administering a deferred compensation program comprising:
receiving from a service provider an election of a predetermined amount of the service provider's compensation that will be deferred;
selecting one or more initial payment dates over a predetermined period of time on which at least a portion of such amount of compensation will be paid to the service provider;
as compensation is earned by the service provider, deferring such compensation by allocating an approximately equal portion of such compensation for payment on each of the initial payment dates; and
on a predetermined time prior to each initial payment date, automatically rescheduling payment of the portion of such amount of compensation that was allocated for payment to the service provider on such initial payment date to a subsequent payment date in the future without further action on by the service provider.

23. A method of administering a deferred compensation program as defined in claim 24 wherein such allocating and automatic rescheduling steps are performed by a computer.

24. A method of administering a deferred compensation program as defined in claim 24 wherein all method steps are performed by a party other than the service provider and the party compensating such service provider.
